(19) United States
(12) Patent Application Publication
(10) Pub. No.: US 2006/0143100 A1
(43) Pub. Date: Jun. 29, 2006

(54) Variable incentive fee for hedge funds and other pooled investment vehicles and separate accounts

(76) Inventor: Arnold Plonski, Randolph, NJ (US)

Correspondence Address: PITNEY HARDIN LLP, 7 TIMES SQUARE, NEW YORK, NY, 10036-7311, US

(21) Appl. No.: 11/024,116

(22) Filed: Dec. 28, 2004

(51) Int. Cl. G06Q 40/00

(52) U.S. Cl. 705/35

(57) ABSTRACT

An incentive fee for a manager of a hedge fund or other pooled investment vehicle or separate investment account is disclosed. The percentage of the gains that is allocated to the incentive fee is proportional to the percentage gains of the underlying fund or account.

### BACKGROUND OF THE INVENTION

1. Field of the Invention

This invention pertains to a variable incentive fee for the manager or someone acting in a similar capacity for a hedge fund, or other pooled investment vehicle, such as a mutual fund, or for a separate account for a single investor.

2. Description of the Prior Art

It is well known in the prior art that compensation in general, and incentive fees in particular, for a manager or someone acting in a similar capacity for a hedge fund or similar pooled investment vehicle or other account can be problematic.

Compensation based upon transaction volume typically generates excessive brokerage and other transaction fees, and can result in “churning” of accounts. Similarly, compensation based on total assets under management gives the manager little incentive to outperform market indices or other funds.

Recently, particularly in the management of hedge funds, the funds would charge investors a fixed fee plus an incentive fee of typically 5-25% of the fund's annual return. It has been thought that these incentive fees align manager interests with investor interests. Moreover, it has been thought that better managers would gravitate to the investment pools with the most promising incentive fees, and that capital would similarly gravitate to the funds with the best managers.

However, such an incentive fee may still over-reward mediocre performance (particularly in a generally rising market in that incentive fees may be awarded for underperforming the market) and under-reward truly outstanding performance.

Other compensation systems base the incentive fee upon whether the fund over-performs or under-performs a given index (such as the S & P 500).

However, it has still been found and, indeed, quantified, that many such compensation systems still do not align the manager's interests with the interests of the investors in the fund in that they encourage and ultimately reward excessive risk-taking. In fact, the incentive fee can be easily visualized, analyzed and discussed as an option with a strike price based on the net asset value of the fund measured at the beginning of the option life. Other compensation schemes would subsequently vary the strike price based upon the index upon which the incentive fee is based. In either event, there is an incentive for the manager to undertake an inappropriate amount of risk in order to optimize the option-like value of the incentive fee. This amount of risk typically does not optimize the position of the fund investor. This incentive to increase the volatility of the return distribution on the same capital creates a conflict of interest between the manager and the investors in the fund. This is further discussed in “Pricing Incentive Fee of Hedge Fund Managers: A Discussion of Moral Hazard” by Maria Elena De Giuli, Mario Alessandro Maggi and Francesco Maria Paris and “Incentive Fees and Mutual Funds” by Edwin J. Elton, Martin J. Gruber and Christopher R. Blake.

### OBJECTS AND SUMMARY OF THE INVENTION

It is therefore an object of the present invention to provide an incentive fee for an investment manager that tends to align the manager's interests with the interests of the investors in the fund or in the separate accounts managed by that manager.

It is therefore a further object of the present invention to provide an incentive fee for an investment manager that tends to attract both the best managers and the most capital to a hedge fund or other pooled investment vehicle or other account.

It is therefore a still further object of the present invention to provide an incentive fee for an investment manager that adequately rewards outstanding performance while not over-rewarding mediocre performance.

These and other objects are attained by providing an incentive fee wherein the percentage of the gains that are allocated to the manager is proportional to the performance of the fund or account. In other words, if the fund or account has a ten percent annual return, the incentive fee could equal ten percent of the total return (measured in dollars). Similarly, if the fund or account has a twenty percent annual return, the incentive fee could equal twenty percent of the total return (measured in dollars). For instance, if a hedge fund started the year with ten million dollars and ended the year with eleven million dollars (no contributions or withdrawals were made during the year, resulting in a ten percent gain), then the incentive fee would be ten percent of the one million dollar gain, or $100,000. Different proportions of the annual return could be used to calculate the incentive fee (such as one half of the return, a ten percent gain resulting in an incentive fee of five percent of the total gain).

Typically, such an incentive fee calculation would require an upper limit on the percentage of the gain that is allocated to the incentive fee in order to prevent the incremental amounts of incentive fees from exceeding the corresponding incremental returns, particularly in an environment of high returns. In other words, a one hundred percent return cannot result in the incentive fee being equal to the entire net gain.

### DESCRIPTION OF THE DRAWINGS

Further objects and advantages of the invention will become apparent from the following description and claims, and from the accompanying drawings, wherein:

FIG. 1 is a diagram of the cash flow to the investor and the manager in a hedge fund using the method of the present invention.

FIG. 2 is a block diagram of the method of the present invention.

FIG. 3 is a diagram illustrating the capping of the incentive fee prescribed by the method of the present invention.

### DETAILED DESCRIPTION OF THE PREFERRED EMBODIMENT

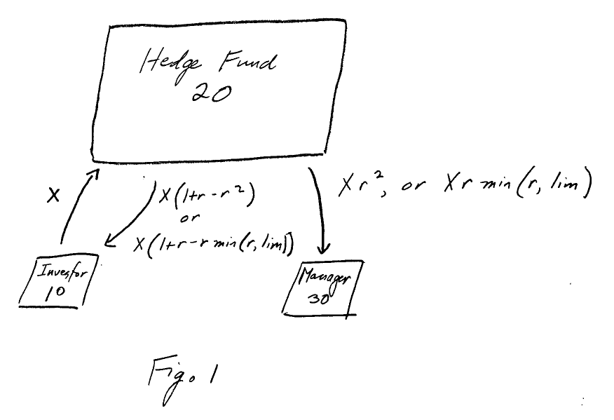

Referring now to the drawings in detail wherein like numerals indicate like elements throughout the several views, one sees from FIG. 1 the basic cash flows for the present invention. This cash flow is simplified to show a single investor investing money for a given period such as one year, after which the money can remain in the fund or be withdrawn.

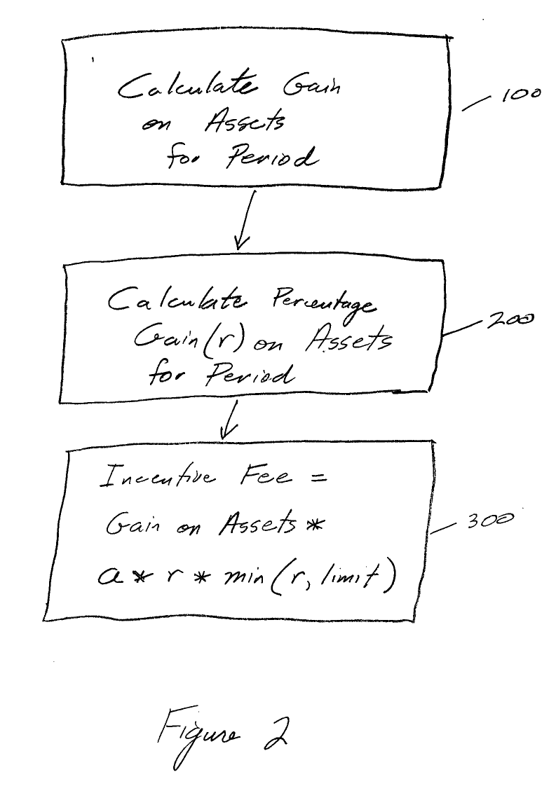

Investor 10 invests X dollars into hedge fund 20 that is run by manager 30. After one year, the X dollars is now worth X(1+r) where r is the return expressed as a decimal number (that is, a fifty percent return is indicated by r=0.50). See steps 100 and 200 on FIG. 2. The incentive fee is therefore r times the total dollar gain of Xr. Therefore, for lower values of r, the incentive fee is Xr² (higher values of r will require a calculation of Xr min(r, limit) as will be explained hereinafter) leaving X(1+r−r²) (or, for higher values of r, X(1+r−r min(r, limit)) in the account of the investor (see step 300 on FIG. 2), that can be withdrawn or left in the account, depending on the terms of the agreement. While not shown in FIG. 1, there can still be an underlying management fee, perhaps one or two percent of total assets under management.

Additionally, variations include having a minimum percentage of the gain as an incentive fee, or having zero incentive fee for percentage gains under a given threshold. Moreover, the percentage of the gain which is used as the incentive fee can be calculated at the beginning of a step or interval of percentage gains and applied throughout the entire step or interval. For instance, the percentage of the gain for a two percent gain can be applied to all gains between two and four percent in the calculation of an incentive fee.

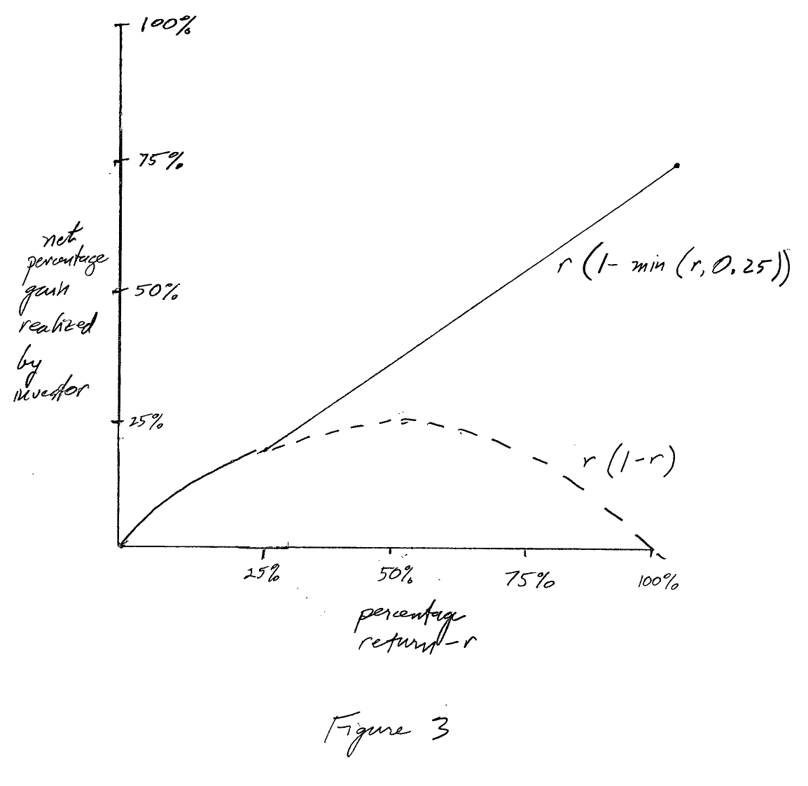

Of course, different fractions can be used with this method, such as the incentive fee being ½ Xr² (variable “a” in step 300 of FIG. 2). Similarly, the value of r can be calculated for some other time period than one year. Indeed, some pooled investment vehicles (such as private equity funds) may have a longer time horizon than one year. In any event, simple calculus can show that at higher returns, further incremental increases in returns can result in increments in the incentive fee that are greater than the corresponding gains in returns. For instance, when the incentive fee is expressed as Xr², without limit, and the total return (r) is equal to 0.5, the investor realizes a 25% net gain, but when the total return (r) increases to 0.6, the investor's net gain is reduced to a 24% gain. Therefore, the incentive fee must be capped at some number, typically 35-50% of total gains. This is illustrated in FIG. 3 wherein the net percentage gain realized by the investor is plotted versus r, wherein the solid line on the left shows the return for r ranging from zero to 0.25 (net percentage return=r−r²), and the solid line to the right shows the net percentage gain realized with the cap on the percentage of the gains allocated as an incentive fee (the incentive fee being Xr min(r, 0.25)), while the dotted line to the right shows the mathematical behavior of (r−r²) without a cap on the incentive fee. The dotted line indeed illustrates that, without a cap, the net percentage gain to the investor would indeed decrease at higher investment returns, and would eventually reach zero when the underlying investment had increased by one hundred percent.

Thus the several aforementioned objects and advantages are most effectively attained. Although a single preferred embodiment of the invention has been disclosed and described in detail herein, it should be understood that this invention is in no sense limited thereby and its scope is to be determined by that of the appended claims.

What is claimed is:

1. A method for calculating an incentive fee for a manager of a pooled investment vehicle or separate account, comprising the steps of:
calculating a total gain on assets for a given period;
calculating a percentage gain for the given period;
multiplying the percentage gain times the total gain to calculate the incentive fee.

2. The method of claim 1 wherein said step of multiplying the percentage gain times the total gain employs a limit on the percentage gain.

3. The method of claim 1 wherein said given period is one year.

4. A method for calculating an incentive fee for a manager of a pooled investment vehicle or separate account, comprising the steps of:
calculating a total gain on assets for a given period;
calculating a percentage gain for the given period;
multiplying the percentage gain times the total gain times a predetermined number to calculate the incentive fee.

5. The method of claim 4 wherein said step of multiplying the percentage gain times the total gain employs a limit on the percentage gain.

6. The method of claim 4 wherein said given period is one year.

7. The method of claim 4 wherein said incentive fee is no less than a given percentage of said total gain.

8. The method of claim 4 wherein said incentive fee is zero for any percentage gain less than a given threshold.

9. The method of claim 4 wherein the percentage of the gain which is the incentive fee is calculated at the beginning of an interval of percentage gains and applied throughout said interval of percentage gains.
